(19) United States
(12) Patent Application Publication
(10) Pub. No.: US 2007/0146613 A1
(43) Pub. Date: Jun. 28, 2007

(54) Liquid crystal display

(75) Inventor: De-Ching Shie, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/644,680

(22) Filed: Dec. 22, 2006

(30) Foreign Application Priority Data
Dec. 23, 2005 (CN) 200510121245.0

(51) Int. Cl. G02F 1/1345

(52) U.S. Cl. 349/149

(57) ABSTRACT

An exemplary liquid crystal display (50) includes a plurality of integrated circuit bonding regions (51), a plurality of flexible printed circuit bonding regions (52), and a plurality of wires (53). Each of the integrated circuit bonding regions is electrically coupled to a corresponding one of the flexible printed circuit bonding regions by a corresponding one of the wires. The wire includes a joint portion (531) connecting with the integrated circuit bonding region, and a total length of the joint portion that interfaces with the integrated circuit bonding region is greater than a length of a side of the integrated circuit bonding region that is nearest to the flexible printed circuit bonding region.

### FIELD OF THE INVENTION

The present invention relates to liquid crystal displays (LCDs), and particularly to a liquid crystal display having wires configured for mitigating the effects of electrostatic discharge (ESD) and thereby resisting damage.

### BACKGROUND

A typical LCD includes a plurality of ICs (integrated circuits) and an FPC (flexible printed circuit). The ICs are used for operating the LCD, and the FPC interconnects various electronic components and elements of the LCD. Nowadays, it is customary for the ICs and the FPC to be directly bonded onto a main substrate of the LCD via an ACF (anisotropic conductive film). Generally, bonding regions are pre-formed at the substrate, and a part of each of the bonding regions is electrically connected with one or more metal conducting wires.

Referring to FIG. 3, a typical substrate 10 of a liquid crystal display includes a plurality of driving IC bonding regions 11, a plurality of FPC bonding regions 12, and a plurality of metal conducting wires 13. The driving IC bonding regions 11 are used to bond one or more driving ICs thereat, and the FPC bonding regions 12 are used to bond an FPC thereat. Each of the driving IC bonding regions 11 is electrically coupled to a corresponding FPC bonding region 12 by a corresponding wire 13. A width of the wire 13 progressively decreases from the FPC bonding region 12 to the driving IC bonding region 11. That is, the width of an end portion 131 of the wire 13 adjacent to the driving IC bonding region 11 is less than the width of an opposite end (not labeled) of the wire 13 adjacent to the FPC bonding region 12.

However, when electrostatic discharge (ESD) occurs in the liquid crystal display, electric charges are liable to transfer between FPC bonding regions 12 and corresponding driving IC bonding regions 11 via the wires 13. Because the end portions 131 of the wires 13 have the least width, electric charges concentrate at the end portions 131 of the wires 13. When this happens, the wires 13 are liable to bum out and break the corresponding circuits. Therefore, the liquid crystal display with the substrate 10 may have poor reliability.

Accordingly, what is needed is a liquid crystal display that can overcome the above-described deficiencies.

### SUMMARY

An exemplary liquid crystal display includes a plurality of integrated circuit bonding regions, a plurality of flexible printed circuit bonding regions, and a plurality of wires. Each of the integrated circuit bonding regions is electrically coupled to a corresponding one of the flexible printed circuit bonding regions by a corresponding one of the wires. The wire includes a joint portion connecting with the integrated circuit bonding region, and a total length of the joint portion that interfaces with the integrated circuit bonding region is greater than a length of a side of the integrated circuit bonding region that is nearest to the flexible printed circuit bonding region.

Another exemplary liquid crystal display includes a plurality of first bonding regions, a plurality of second bonding regions, and a plurality of wires. Each of the first bonding regions is electrically coupled to a corresponding second bonding region by a wire. The wire includes a joint portion connecting with the first bonding region. The joint portion partly or entirely surrounds edges of the integrated circuit bonding region.

Other advantages and novel features will become apparent from the following detailed description of preferred embodiments when taken in conjunction with the accompanying drawings. In the drawings, all the views are schematic.

### BRIEF DESCRIPTION OF THE DRAWINGS

FIG. 1 is an abbreviated, top plan view of part of a liquid crystal display according to a first embodiment of the present invention.

FIG. 2 is an abbreviated, top plan view of part of a liquid crystal display according to a second embodiment of the present invention.

FIG. 3 is an abbreviated, top plan view of part of a substrate of a conventional liquid crystal display.

### DETAILED DESCRIPTION OF PREFERRED EMBODIMENTS

Reference will now be made to the drawings to describe the preferred embodiments in detail.

Referring to FIG. 1, an abbreviated, top plan view of part of a liquid crystal display according to a first embodiment of the present invention is shown. The liquid crystal display 50 includes a plurality of driving IC bonding regions 51, a plurality of FPC bonding regions 52, and a plurality of metal conducting wires 53. The driving IC bonding regions 51 are used to bond one or more driving ICs thereat, and the FPC bonding regions 52 are used to bond an FPC thereat. Each of the driving IC bonding regions 51 is electrically coupled to a corresponding FPC bonding region 52 by a corresponding wire 53.

Each driving IC bonding region 51 has a rectangular shape. The corresponding wire 53 defines a joint portion 531 connecting with three sides of the driving IC bonding region 51. That is, the joint portion 531 is a generally U-shaped three-sided structure that surrounds and abuts three sides of the driving IC bonding region 51. A combined length of the three interfacing sides of the joint portion 531 is much greater than a length of a proximal one of the three sides of the driving IC bonding region 51, said proximal side being the side nearest to the FPC bonding region 52.

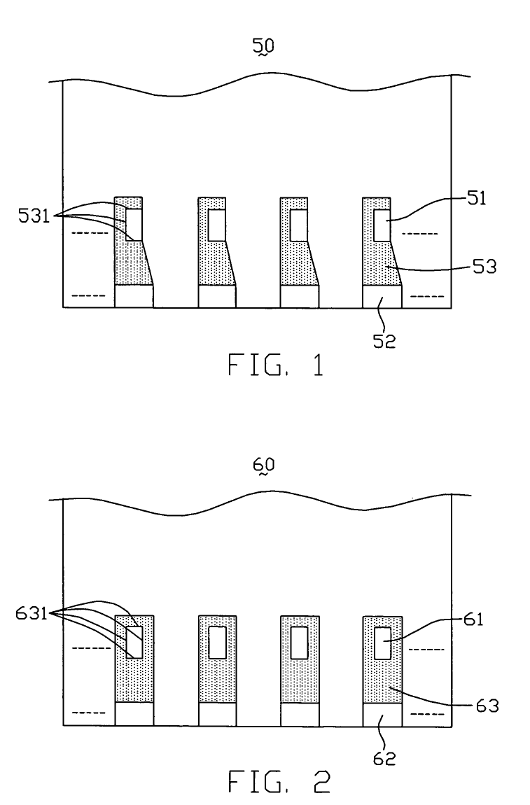

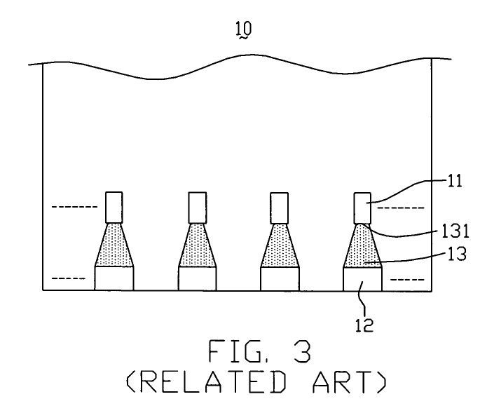

Referring to FIG. 2, an abbreviated, top plan view of part of a liquid crystal display according to a second embodiment of the present invention is shown. The liquid crystal display 60 includes a plurality of driving IC bonding regions 61, a plurality of FPC bonding regions 62, and a plurality of metal conducting wires 63. The driving IC bonding regions 61 are used to bond one or more driving ICs thereat, and the FPC bonding regions 62 are used to bond an FPC thereat. Each of the driving IC bonding regions 61 is electrically coupled to a corresponding FPC bonding region 62 by a corresponding wire 63.

Each driving IC bonding region 61 has a rectangular shape. The corresponding wire 63 defines a joint portion 631 connecting with four sides of the driving IC bonding region 61. That is, the joint portion 631 is a four-sided structure that surrounds and abuts four sides of the driving IC bonding region 61. A combined length of the four interfacing sides of the joint portion 631 is much greater than a length of a proximal one of the four sides of the driving IC bonding region 61, said proximal side being the side nearest to the FPC bonding region 52.

Unlike with a conventional liquid crystal display, the joint portion 531, 631 of each of the wires 53, 63 mostly or entirely surrounds the corresponding driving IC bonding region 51, 61, respectively. That is, the combined length of interfacing sides of the joint portion 531, 631 is much greater than the length of the proximal side of the driving IC bonding region 51, 61 nearest to the FPC bonding region 52, 62, respectively. Therefore, electric charges generated by ESD can discharge over the entire combined length of the interfacing sides of the joint portion 531, 631. This helps prevent the driving IC bonding region 51, 61 from burning out, so that the liquid crystal display 50, 60 can provide high reliability.

Various modifications and alterations are possible within the ambit of the embodiments described herein. For example, each joint portion can form a two-sided surrounding structure. The display device is not limited to being a liquid crystal display. Other kinds of display devices such as plasma display devices can likewise benefit from the above-described structures and functions.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display, comprising:
a plurality of integrated circuit bonding regions;
a plurality of flexible printed circuit bonding regions; and
a plurality of wires;
wherein each of the integrated circuit bonding regions is electrically coupled to a corresponding one of the flexible printed circuit bonding regions by a corresponding one of the wires, the wire includes a joint portion connecting with the integrated circuit bonding region, and a total length of the joint portion that interfaces with the integrated circuit bonding region is greater than a length of a side of the integrated circuit bonding region that is nearest to the flexible printed circuit bonding region.

2. The liquid crystal display as claimed in claim 1, wherein the joint portion interfaces with two sides of the integrated circuit bonding region.

3. The liquid crystal display as claimed in claim 1, wherein the joint portion interfaces with three sides of the integrated circuit bonding region.

4. The liquid crystal display as claimed in claim 1, wherein the joint portion interfaces with four sides of the integrated circuit bonding region.

5. A liquid crystal display, comprising:
a plurality of first bonding regions;
a plurality of second bonding regions; and
a plurality of wires;
wherein each of the first bonding regions is electrically coupled to a corresponding second bonding region by a wire, and the wire includes a joint portion connecting with the first bonding region, and the joint portion partly or entirely surrounds edges of the integrated circuit bonding region.

6. The liquid crystal display as claimed in claim 5, wherein the joint portion interfaces with two sides of the integrated circuit bonding region.

7. The liquid crystal display as claimed in claim 5, wherein the joint portion interfaces with three sides of the integrated circuit bonding region.

8. The liquid crystal display as claimed in claim 5, wherein the joint portion interfaces with four sides of the integrated circuit bonding region.

9. The liquid crystal display as claimed in claim 5, wherein each of the first bonding regions is a driving integrated circuit bonding region, and each of the second bonding region is a flexible printed circuit board bonding region.

10. A liquid crystal display, comprising:
a plurality of first bonding regions;
a plurality of second bonding regions; and
a plurality of wires;
wherein each of the first bonding regions is electrically coupled to a corresponding second bonding region by a wire, and the wire includes a joint portion connecting with the first bonding region in at least two different directions.
